(19) United States
(12) Patent Application Publication
(10) Pub. No.: US 2025/0136295 A1
(43) Pub. Date: May 1, 2025

(54) METHOD AND SYSTEM FOR OPTIMIZING THE MAINTENANCE OF AN AIRCRAFT STRUCTURE AGAINST CORROSION

(71) Applicants: Airbus Operations (S.A.S.), Toulouse (FR); Airbus Operations GmbH, Hamburg (DE)

(72) Inventors: Martin Beneke, Hamburg (DE); Alexandra Luce, Hamburg (DE); Romain Ecault, Toulouse (FR); Marine Chesneau, Toulouse (FR)

(21) Appl. No.: 18/929,865

(22) Filed: Oct. 29, 2024

(30) Foreign Application Priority Data
Oct. 30, 2023 (FR) 2311809

(51) Int. Cl. B64F 5/60; G07C 5/00; G07C 5/08

(52) U.S. Cl. CPC B64F 5/60; G07C 5/008; G07C 5/0808

(57) ABSTRACT

A method and system for optimizing the maintenance of an aircraft structure against corrosion includes a step of collecting corrosion incidents on aircrafts, a step of determining zones and corrosion incident rates in each of the zones, a step of determining zones at risk, a step of determining a depth of corrosion, a step of determining a rate of corrosion, a step of determining a proposed inspection frequency for each of the zones at risk based on its rate of corrosion and a predetermined limit depth of each of the zones at risk. A proposed inspection frequency can be obtained that is more accurate and suited to the different parts of the aircraft structure.

### TECHNICAL FIELD

The disclosure herein relates to a method for optimizing maintenance of an aircraft structure, for example the fuselage or aircraft wings, against corrosion.

### BACKGROUND

Currently, when an aircraft is being manufactured, the parts of the aircraft structure, and notably the parts of the wings or of the fuselage of the aircraft, undergo different levels of protection against corrosion. This protection depends, among other things, on the location and the function of the parts.

For example, the fuselage parts situated in the lower part of the aircraft generally require protection against corrosion that is higher than the protection for the parts situated in the upper part of the aircraft. Similarly, the movable fuselage parts, such as the doors or the landing gear case, generally require protection against corrosion that is greater than the protection for the fixed fuselage parts.

There are currently different levels of protection against corrosion, namely, in an increasing ascending order from the least important to the most important: level 1, level 2, level 3 and level 4.

The protection against corrosion is established at the individual part level and the assembly level.

The protection provided at the individual part level comprises four levels:

Level 1 comprises a surface treatment, such as tribofinishing, cadmium plating, anodization, galvanization, etc. Level 1 also comprises an installation without mastic.

Level 2 comprises a surface treatment and a layer of paint. Level 2 also comprises an installation with mastic interposed between two parts.

Level 3 comprises a surface treatment and two layers of paint. Level 3 also comprises an installation with mastic interposed between two parts, as well as a bead of mastic over the entire perimeter.

Level 4 comprises a surface treatment, two layers of paint and a waterproofing treatment. Level 4 also comprises an installation with mastic interposed between two parts, as well as a bead of mastic covering the edges.

Moreover, the fuselage parts are classified in different categories as a function of their need for protection against corrosion: category 1, category 2, category 3, category 4 and category 5.

Category 1 comprises the parts and the assemblies which require

little protection against corrosion (levels 1 and 2).

Category 2 comprises the parts which require the protection level 2 and the assemblies which require the protection level 3.

Categories 3 and 4 comprise the parts and the assemblies which require the protection level 3.

Category 5 comprises the parts and the assemblies which require the protection level 3 or 4.

There is currently a two-dimensional mapping of the aircraft indicating the corrosion zones and the respective protection categories of each of the fuselage parts, as well as the frequencies of inspection of the various parts (FIG. 3).

However, this mapping is fixed, and is not necessarily optimal.

Indeed, the rate of corrosion of an aircraft can differ depending on the use that is made of it and according to the climate in which it is usually used. The current fixed mapping is not therefore fully satisfactory.

### SUMMARY

The object of the disclosure herein is to mitigate the drawbacks mentioned above, and in particular to take account of the environmental constraints to adapt maintenance inspection intervals.

For that, it relates to a method for optimizing maintenance of an aircraft structure against corrosion, the aircraft structure comprising at least one aircraft structure part.

According to the disclosure herein, the method comprises the following steps:
a collection step implemented by a collecting unit for collecting a plurality of corrosion incidents on a plurality of aircraft, each of the corrosion incidents comprising a position of the corrosion incident, a remaining thickness of the aircraft structure part at the position of the corrosion incident and an age of the aircraft for which the corrosion incident has been collected,
a reporting step implemented by a reporting unit for reporting the plurality of corrosion incidents collected on a digital twin virtually defining an aircraft structure in three dimensions comprising nominal thicknesses of at least one aircraft structure part,
a first determination step implemented by a first determining unit for determining zones and corrosion incident rates in each of the zones for each part of the aircraft structure of the digital twin, the corrosion incident rate of each of the zones being equal to a ratio between number of corrosion incidents collected in each of the zones and a number of aircraft of the plurality of aircraft on which the plurality of corrosion incidents have been collected,
a second determination step implemented by a second determining unit for determining zones at risk, the zones at risk corresponding to the zones for which the corrosion incident rate is greater than or equal to a predetermined corrosion incident rate,
a third determination step implemented by a third determining unit for determining a depth of corrosion for each part of the aircraft structure located in the zones at risk from the remaining thickness,
a fourth determination step implemented by a fourth determining unit for determining a rate of corrosion for each of the zones at risk based on the depth of corrosion and from the age of the aircraft for each part of the aircraft structure comprising a zone at risk,
a fifth determination step implemented by a fifth determining unit for determining a proposed inspection frequency for each of the zones at risk based on its rate of corrosion and a predetermined limit depth of each of the zones at risk,
a transmission step implemented by a transmitting unit for transmitting to a user device the proposed frequency of inspection of each of the zones at risk.

Thus, by virtue of the determination of zones on the parts of the aircraft structure for which there are high corrosion incident rates, it is possible to more accurately and more appropriately determine the inspection frequencies necessary before excessive corrosion appears.

The proposed inspection frequency corresponds to a correction of the inspection frequency initially defined for the maintenance. The inspection frequency initially defined for the maintenance can therefore be adapted on the basis of the plurality of corrosion incidents collected, when it is determined that the inspection intervals are not defined optimally.

The maintenance plan of the aircraft can thus be optimized, by making it possible to reduce the frequencies of inspection of the zones at risk, and therefore limit the downtimes of the aircraft and reduce the maintenance tasks to be carried out.

Advantageously, the first determination step comprises the following substeps:
a first cutting substep implemented by a first cutting subunit for cutting each part of the aircraft structure of the digital twin according to a meshing of zones comprising zones of predetermined size,
a first computation substep implemented by a first computing subunit for calculating a corrosion incident rate for each of the zones of the meshing of zones.

In addition, the first determination step further comprises the following substeps implemented if at least two zones of the meshing of zones of a part of the aircraft structure exhibits a difference in corrosion incident rate greater than a predetermined difference:
a second cutting substep implemented by a second cutting subunit for cutting the part of the aircraft structure according to a submeshing of zones comprising zones of predetermined size less than the predetermined size of the zones of the meshing of zones,
a second computation substep implemented by a second computing subunit for calculating a corrosion incident rate for each of the zones of the submeshing of zones.

Moreover, the depth of corrosion of a part of the aircraft structure determined in the third determination step is equal to a difference between a nominal thickness of the part of the aircraft structure and the remaining thickness of the part of the aircraft structure.

Furthermore, the rate of corrosion of each of the zones at risk determined in the fourth determination step is equal to a ratio between the average depth of corrosion in each of the zones at risk over a time at the end of which this depth of corrosion is reached.

Moreover, the fifth determination step comprises the following substeps:
a third computation substep implemented by a third computing subunit for calculating the inspection frequency necessary for each of the zones at risk for the depth of corrosion to reach the predetermined limit depth,
a determination substep implemented by a determining subunit for determining the proposed inspection frequency, the proposed inspection frequency being strictly less than the inspection frequency necessary for each of the zones at risk for the depth of corrosion to reach the predetermined limit depth.

The disclosure herein relates also to a system for optimizing maintenance of an aircraft structure against corrosion, the aircraft structure comprising at least one part of the aircraft structure.

According to the disclosure herein, the optimization system comprises:
a collecting unit for collecting a plurality of corrosion incidents on a plurality of aircraft, each of the corrosion incidents comprising a position of the corrosion incident, a remaining thickness of the part of the aircraft structure at the position of the corrosion incident and an age of the aircraft for which the corrosion incident has been collected,
a reporting unit for reporting the plurality of corrosion incidents collected on a digital twin virtually defining the aircraft structure in three dimensions comprising nominal thicknesses of at least one part of the aircraft structure,
a first determining unit for determining zones and corrosion incident rates in each of the zones for each aircraft structure part of the digital twin, the corrosion incident rate of each of the zones being equal to a ratio between number of corrosion incidents collected in each of the zones and a number of aircraft of the plurality of aircraft on which the plurality of corrosion incidents have been collected,
a second determining unit for determining zones at risk, the zones at risk corresponding to zones for which the corrosion incident rate is greater than or equal to a predetermined corrosion incident rate,
a third determining unit for determining a depth of corrosion for each part of the aircraft structure located in each of the zones at risk based on the remaining thickness,
a fourth determining unit for determining a rate of corrosion for each of the zones at risk based on the depth of corrosion and on the age of the aircraft for each part of the aircraft structure comprising a zone at risk,
a fifth determining unit for determining a proposed frequency of inspection of each of the zones at risk based on its rate of corrosion and on a predetermined limit depth of each of the zones at risk,
a transmitting unit for transmitting to a user device the proposed frequency of inspection of each of the zones at risk.

Advantageously, the first determining unit comprises:
a first cutting subunit for cutting each part of the aircraft structure of the digital twin according to a meshing of zones comprising zones of predetermined size,
a first computing subunit for calculating a corrosion incident rate for each of the zones of the meshing of zones.

In addition, the first determining unit further comprises:
a second cutting subunit for cutting the part of the aircraft structure according to a submeshing of zones comprising zones of predetermined size less than the predetermined size of the zones of the zone meshing,
a second computing subunit for calculating a corrosion incident rate for each of the zones of the submeshing of zones.

Moreover, the fifth determining unit comprises:
a third computing subunit for calculating the inspection frequency necessary for each of the zones at risk for the depth of corrosion to reach the predetermined limit depth,
a determining subunit for determining the proposed inspection frequency, the proposed inspection frequency being strictly less than the inspection frequency necessary for each of the zones at risk for the depth of corrosion to reach the predetermined limit depth.

### BRIEF DESCRIPTION OF THE DRAWINGS

The attached figures will give a good understanding of how the disclosure herein can be produced. In these figures, identical references designate similar elements.

FIG. 1 schematically represents the optimization method.

FIG. 2 schematically represents a cross-section of a fuselage part having a nominal thickness.

FIG. 3 represents a two-dimensional fixed mapping of an aircraft having fuselage parts to which protection categories have been assigned.

FIG. 4 represents a part of a digital aircraft twin to which collected corrosion incidents have been added.

FIG. 5 represents two curves of the changing depth of corrosion of a fuselage part as a function of time.

FIG. 6 schematically represents the optimization system.

FIG. 7 represents a profile view of an aircraft of the plurality of aircraft on which the corrosion incidents are collected.

### DETAILED DESCRIPTION

The optimization method is represented schematically in FIG. 1.

The optimization method is intended to optimize maintenance of an aircraft structure, or of a part of an aircraft, including the wings and the aircraft structure, against corrosion. The aircraft structure is defined here as being the mechanical structure of an aircraft AC, also called “airframe” of the aircraft AC. Hereinafter in the description, the method will be described for a fuselage 1, but it is of course applicable to the other elements of the structure of the aircraft, such as the wings. The fuselage 1 comprises at least one fuselage part 4.

The optimization method comprises the following steps:
a collection step E1 implemented by a collecting unit COL 10,
a reporting step E2 implemented by a reporting unit REP 12,
a first determination step E3 implemented by a first determining unit DET1 13,
a second determination step E4 implemented by a second determining unit DET2 14,
a third determination step E5 implemented by a third determining unit DET3 15,
a fourth determination step E6 implemented by a fourth determining unit DET4 16,
a fifth determination step E7 implemented by a fifth determining unit DET5 17,
a transmission step E8 implemented by a transmitting unit TRANS 18.

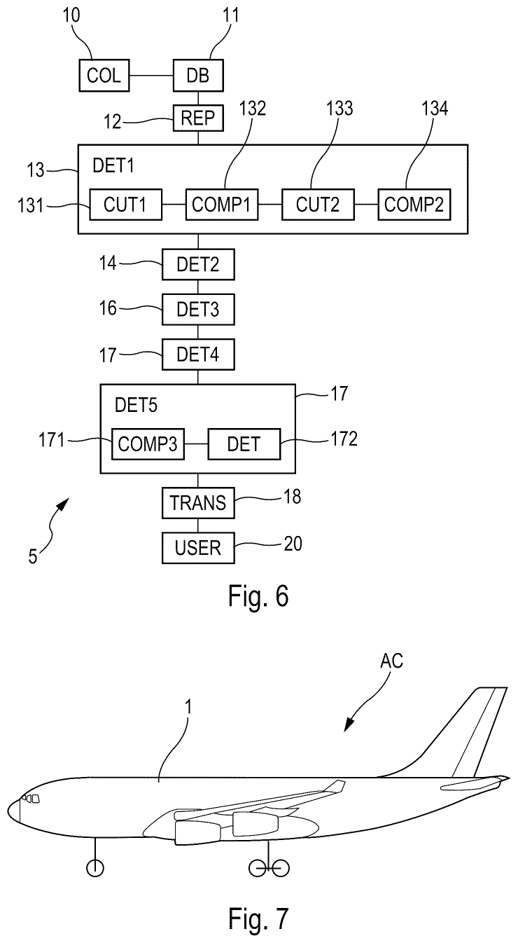

The collection step E1 is intended to be implemented to collect a plurality of corrosion incidents 6 on a plurality of aircraft AC such as that represented in FIG. 7. Each of the corrosion incidents 6 comprises parameters including a position of the corrosion incident 6, a remaining thickness Ea of the fuselage part 4 at the position of the corrosion incident 6 and an age of the aircraft AC for which the corrosion incident 6 has been collected. For example, in this collection step E1, the plurality of corrosion incidents are collected and stored in a database DB 11. The collecting unit 10 can correspond to an input device, such as a keyboard. The database 11 can thus combine the in-service feedback from the plurality of aircraft AC.

The term “corrosion incident” refers to a fuselage region or zone 1 which includes a corrosion. The corrosion incident comprises at least the position on the fuselage 1 of the region which includes the corrosion. The position can correspond to a position of a corroded surface.

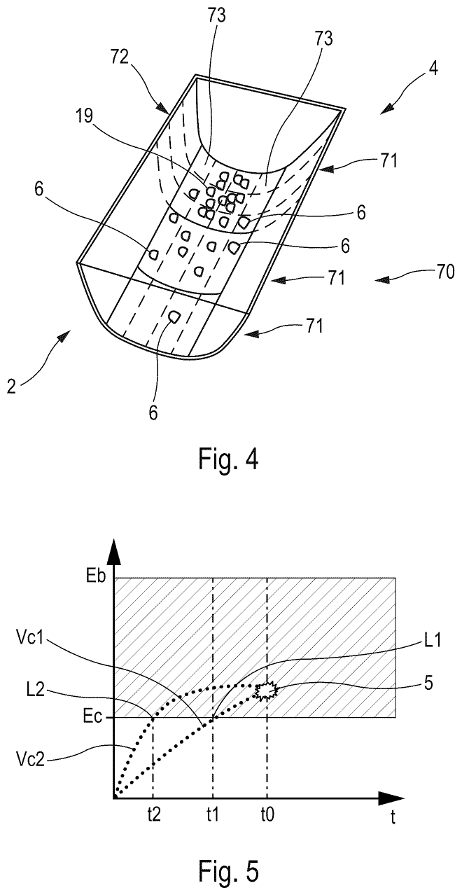

The reporting step E2 is intended to be implemented to report the plurality of corrosion incidents 6 collected on a digital twin 2 simulating a fuselage 1 comprising at least one fuselage part 4. Thus, each of the corrosion incidents 6 is reported on the digital twin 2 at their respective position (FIG. 4). FIG. 4 represents a fuselage part 4 of the digital twin 2 or a part of the fuselage 1 of the digital twin 2.

The digital twin 2 corresponds to a modeling of an aircraft AC in three dimensions. This modeling can be implemented by a processor of a calculator, such as a computer.

The first determination step E3 is intended to be implemented to determine zones 71, 73 and corrosion incident rates in each of the zones 71, 73 for each part 4 of the fuselage of the digital twin 2. The corrosion incident rate of each of the zones 71, 73 is equal to a ratio between a number of corrosion incidents 6 collected in each of the zones 71, 73 of the plurality of aircraft AC and a number of aircraft AC equal to the number of aircraft of the plurality of aircraft AC.

The first determination step E3 can comprise the following substeps:
a first cutting substep E31 implemented by a first cutting subunit CUT1 131 (CUT for “cutting unit”),
a first computation substep E32 implemented by a first computing subunit COMP1 132 (COMP for “computing unit”).

The first cutting substep E31 is intended to be implemented to cut each fuselage part 4 of the digital twin 2 according to a meshing of zones 70 comprising zones 71 of predetermined size.

The meshing of zones 70 can correspond to a meshing having cells of square form or any other form suited to the part 4. These cells correspond to the zones 71.

FIG. 4 represents a meshing of zones 70 in solid lines. This meshing of zones 70 defines the zones 71. The predetermined size of the zones 71 depends on the accuracy that is wanted to determine the corrosion incident rates determined for each of the zones 71. The zones 71 of the meshing of zones 70 can have a size that is smaller than the size of a fuselage part 4.

The first computation substep E32 is intended to be implemented to calculate a corrosion incident rate for each of the zones 71 of the meshing of zones 70.

Moreover, the first determination step E3 can further comprise the following substeps:
a second cutting substep E33 implemented by a second cutting subunit CUT2 133,
a second computation substep E34 implemented by a second computing subunit COMP2 134.

The substeps E33 and E34 are implemented if at least two zones 71 of the meshing of zones 70 of a fuselage part 4 exhibit a difference in corrosion incident rate greater than a predetermined difference.

The second substep E33 is intended to be implemented to cut the fuselage part 4 according to a submeshing of zones 72 comprising zones 73 of predetermined size less than the predetermined size of the zones 71 of the meshing of zones 70.

For example, a zone 71 of the meshing of zones 70 is cut by a submeshing of zones 72 comprising zones 73. As for the meshing of zones 70, the submeshing of zones 72 can correspond to a meshing having cells of square form or any other form suited to the part 4 or to the cells of the meshing of zones 70. These cells of the submeshing of zones 72 correspond to the zones 73.

For example, FIG. 4 presents, in dotted lines, a submeshing of zones 72 comprising zones 73 having a size less than the size of the zones 71.

The second computation substep E34 is intended to be implemented to calculate a corrosion incident rate for each of the zones 73 of the submeshing of zones 72.

The second determination step E4 is intended to be implemented to determine zones at risk 19. The zones at risk 19 correspond to the zones 71, 73 for which the corrosion incident rate is greater than or equal to a predetermined corrosion incident rate (FIG. 4).

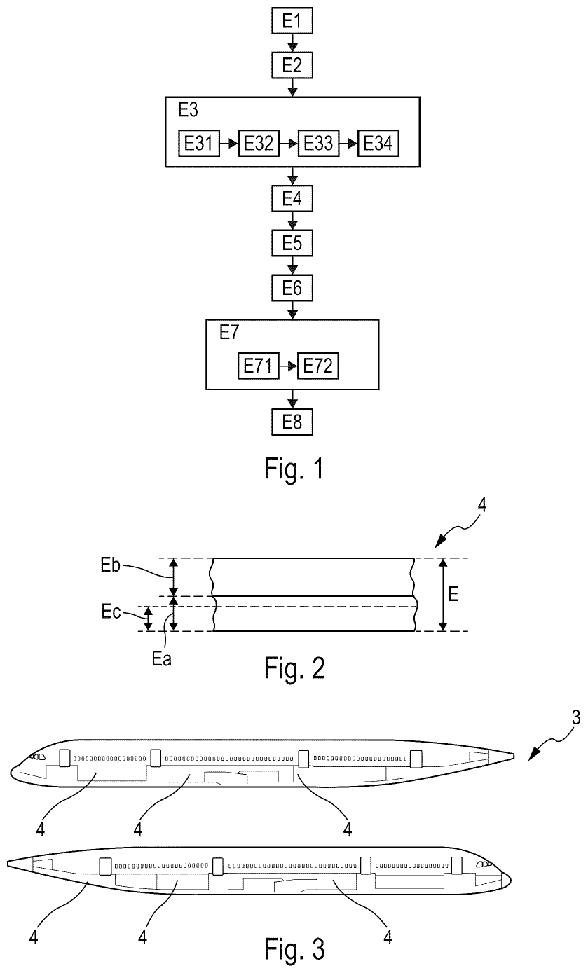

The third determination step E5 is intended to be implemented to determine a depth of corrosion Eb for each fuselage part 4 located in the zones at risk 19 based on the remaining thickness Ea (FIG. 2).

The depth of corrosion Eb of a fuselage part 4 can be equal to a difference between a nominal thickness E of the fuselage part 4 and the remaining thickness Ea of the fuselage part 4.

The fourth determination step E6 is intended to be implemented to determine a rate of corrosion for each of the zones at risk 19 based on the depth of corrosion Eb and the age of the aircraft for each fuselage part 4 including a zone at risk 19.

The rate of corrosion of each of the zones at risk 19 can be equal to a ratio between the average depth of corrosion Eb in each of the zones at risk 19 over a time at the end of which this depth of corrosion Eb is reached.

According to a variant embodiment, the rate of corrosion determined in the fourth determination step E6 can be modulated by at least one parameter dependent on the climate or on the climatic conditions in which the aircraft are likely to fly.

The fifth determination step E7 is intended to be implemented to determine a proposed inspection frequency for each of the zones at risk 19 based on its rate of corrosion and on a predetermined limit depth Ec of each of the zones at risk 19. Each fuselage part 4 can have a predetermined limit depth Ec different from the other fuselage parts 4. This predetermined limit depth Ec can depend on a limit thickness of the part 4 considered or on a minimum thickness authorized for the corrosion of the part 4 considered.

The fifth determination step E7 can comprise the following substeps:
a third computation substep E71 implemented by a third computing subunit COMP3 171,
a determination substep E72 implemented by a determining subunit DET 172.

The third computation substep E71 is intended to be implemented to calculate the inspection frequency necessary for each of the zones at risk 19 for the depth of corrosion Eb to reach the predetermined limit depth Ec.

The determination substep E72 is intended to be implemented to determine the proposed inspection frequency. The proposed inspection frequency is strictly less than the inspection frequency necessary for each of the zones at risk 19 for the depth of corrosion Ea to reach the predetermined limit depth Ec.

The transmission step E8 is intended to be implemented to transmit to a user device USER 20 the proposed frequency of inspection of each of the zones at risk 19.

The user device 20 can comprise a display device intended to display the digital twin 2 accompanied by the proposed frequency of inspection of each of the zones at risk 19.

As an example, FIG. 5 represents two curves Vc1 and Vc2 of changing depth of corrosion Eb (for example in millimeters) as a function of time t (for example in years). The line Ec represents the predetermined limit depth. A different change can be noted between the two curves Vc1 and Vc2. This change difference corresponds to a modulation of the rate of corrosion by virtue of the parameter or parameters dependent on the climate or on the climatic conditions in which the aircraft are likely to fly. It can also be noted that a proposed inspection frequency greater than to can be too great to avoid having the predetermined limit depth being reached. Indeed, at to, the curves meet at a point 5 above the predetermined limit depth Ec. Furthermore, according to the change of depth of corrosion Eb, the inspection frequencies can be different according to the modulation parameter or parameters dependent on the climate or on the climatic conditions in which the aircraft are likely to fly. For example, if there is a changing depth of corrosion Eb according to the curve Vc1, there can be a proposed inspection frequency greater at t1 than if there is a change in depth of corrosion Eb according to the curve Vc2 which is at t2.

The disclosure herein relates also to a system S for optimizing maintenance of an aircraft AC fuselage 1 against corrosion (FIG. 6). The system S can be implemented by a processor of a calculator, such as a computer.

The optimization system S comprises:
the collecting unit 10 for collecting a plurality of corrosion incidents 6 on a plurality of aircraft AC,
the reporting unit 12 for reporting the plurality of corrosion incidents 6 collected on the digital twin 2 simulating a fuselage comprising at least one fuselage part 4,
the first determining unit 13 for determining zones and corrosion incident rates in each of the zones 71, 73 for each part 4 of the fuselage of the digital twin 2,
the second determining unit for determining zones at risk 19,
the third determining unit 15 for determining a depth of corrosion Eb for each fuselage part 4 located in each of the zones at risk 19 based on the remaining thickness Ea,
the fourth determining unit 16 for determining a rate of corrosion for each of the zones at risk 19 based on the depth of corrosion Eb and on the age of the aircraft AC for each fuselage part 4 including a zone at risk 19,
the fifth determining unit 17 for determining a proposed frequency of inspection of each of the zones at risk 19 based on its rate of corrosion and on a predetermined limit depth Ec of each of the zones at risk 19,
the transmitting unit 18 for transmitting to a user device 20 the proposed frequency of inspection of each of the zones at risk 19.

The first determining unit 13 can comprise:
the first cutting subunit 131 for cutting each fuselage part 4 of the digital twin 2 according to a meshing of zones 70 comprising zones 71 of predetermined size,
the first computing subunit 132 for computing a corrosion incident rate for each of the zones 71 of the meshing of zones 70.

The first determining unit 13 can further comprise:
the second cutting subunit 133 for cutting the fuselage part 4 according to a submeshing of zones 72 including zones 73 of predetermined size less than the predetermined size of the zones 71 of the meshing of zones 70,
the second computing subunit 134 for calculating a corrosion incident rate for each of the zones 73 of the submeshing of zones 72.

Moreover, the fifth determining unit 17 can comprise:
the third computing subunit 172 for calculating the inspection frequency necessary for each of the zones at risk 19 for the depth of corrosion Eb to reach the predetermined limit depth Ec,
the determining subunit 172 for determining the proposed inspection frequency.

The optimization system S can comprise the database 11 in which are stored the plurality of corrosion incidents 6. However, according to another embodiment, the database can be included in another system distinct from the optimization system S.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for optimizing maintenance of an aircraft structure against corrosion, the aircraft structure comprising at least one aircraft structure part, the method comprising:
a collection step implemented by a collecting unit for collecting a plurality of corrosion incidents on a plurality of aircraft, each of the corrosion incidents comprising a position of the corrosion incident, a remaining thickness of the part of the aircraft structure at the position of the corrosion incident and an age of the aircraft for which the corrosion incident has been collected;
a reporting step implemented by a reporting unit for reporting the plurality of corrosion incidents collected on a digital twin virtually defining an aircraft structure in three dimensions comprising nominal thicknesses of at least one aircraft structure part;
a first determination step implemented by a first determining unit for determining zones and corrosion incident rates in each of the zones for each part of the aircraft structure of the digital twin, the corrosion incident rate of each of the zones being equal to a ratio between a number of corrosion incidents collected in each of the zones and a number of aircraft of the plurality of aircraft on which the plurality of corrosion incidents have been collected;
a second determination step implemented by a second determining unit for determining zones at risk, the zones at risk corresponding to zones for which the corrosion incident rate is greater than or equal to a predetermined corrosion incident rate;
a third determination step implemented by a third determining unit for determining a depth of corrosion for each part of the aircraft structure located in the zones at risk based on the remaining thickness;
a fourth determination step implemented by a fourth determining unit for determining a rate of corrosion for each of the zones at risk based on the depth of corrosion and the age of the aircraft for each part of the aircraft structure including a zone at risk;
a fifth determination step implemented by a fifth determining unit for determining a proposed inspection frequency for each of the zones at risk based on its rate of corrosion and a predetermined limit depth of each of the zones at risk;
a transmission step implemented by a transmitting unit for transmitting to a user device the proposed frequency of inspection of each of the zones at risk.

2. The method of claim 1, wherein the first determination step comprises:
a first cutting substep implemented by a first cutting subunit for cutting each part of the aircraft structure of the digital twin according to a meshing of zones comprising zones of predetermined size;
a first computation substep implemented by a first computing subunit for calculating a corrosion incident rate for each of the zones of the meshing of zones.

3. The method of claim 2, wherein the first determination step further comprises substeps as follows implemented if at least two zones of the meshing of zones of a part of the aircraft structure exhibit a difference in corrosion incident rate greater than a predetermined difference:
a second cutting substep implemented by a second cutting subunit for cutting the part of the aircraft structure according to a submeshing of zones comprising zones of predetermined size less than the predetermined size of the zones of the meshing of zones;
a second computation substep implemented by a second computing subunit for calculating a corrosion incident rate for each of the zones of the submeshing of zones.

4. The method of claim 1, wherein the depth of corrosion of a part of the aircraft structure determined in the third determination step is equal to a difference between a nominal thickness of the part of the aircraft structure and the remaining thickness of the part of the aircraft structure.

5. The method of claim 1, wherein the rate of corrosion of each of the zones at risk determined in the fourth determination step is equal to a ratio between an average depth of corrosion in each of the zones at risk over a time at an end of which this depth of corrosion is reached.

6. The method of claim 1, wherein the fifth determination step comprises:
a third computation substep implemented by a third computing subunit for calculating an inspection frequency necessary for each of the zones at risk for the depth of corrosion to reach the predetermined limit depth;
a determination substep implemented by a determining subunit for determining a proposed inspection frequency, the proposed inspection frequency being strictly less than the inspection frequency necessary for each of the zones at risk for the depth of corrosion to reach the predetermined limit depth.

7. A system for optimizing maintenance of an aircraft structure against corrosion, the aircraft structure comprising at least one aircraft structure part, the system comprising:
a collecting unit for collecting a plurality of corrosion incidents on a plurality of aircraft, each of the corrosion incidents comprising a position of the corrosion incident, a remaining thickness of the part of the aircraft structure at the position of the corrosion incident and an age of the aircraft for which the corrosion incident has been collected;
a reporting unit for reporting the plurality of corrosion incidents collected on a digital twin virtually defining an aircraft structure in three dimensions comprising nominal thicknesses of at least one part of the aircraft structure;
a first determining unit for determining zones and corrosion incident rates in each of the zones for each part of the aircraft structure of the digital twin, the corrosion incident rate of each of the zones being equal to a ratio between number of corrosion incidents collected in each of the zones and a number of aircraft of the plurality of aircraft on which the plurality of corrosion incidents have been collected;
a second determining unit for determining zones at risk, the zones at risk corresponding to the zones for which the corrosion incident rate is greater than or equal to a predetermined corrosion incident rate;
a third determining unit for determining a depth of corrosion for each part of the aircraft structure located in each of the zones at risk based on the remaining thickness;
a fourth determining unit for determining a rate of corrosion for each of the zones at risk based on the depth of corrosion and on the age of the aircraft for each part of the aircraft structure comprising a zone at risk;
a fifth determining unit for determining a proposed frequency of inspection of each of the zones at risk based on its rate of corrosion and on a predetermined limit depth of each of the zones at risk;
a transmitting unit for transmitting to a user device the proposed frequency of inspection of each of the zones at risk.

8. The system of claim 7, wherein the first determining unit comprises:
a first cutting subunit for cutting each part of the aircraft structure of the digital twin according to a meshing of zones comprising zones of predetermined size;
a first computing subunit for calculating a corrosion incident rate for each of the zones of the meshing of zones.

9. The system of claim 8, wherein the first determining unit further comprises:
a second cutting subunit for cutting the part of the aircraft structure according to a submeshing of zones comprising zones of predetermined size less than the predetermined size of the zones of the meshing of zones;
a second computing subunit for calculating a corrosion incident rate for each of the zones of the submeshing of zones.

10. The system of claim 7, wherein the fifth determining unit comprises:
a third computing subunit for calculating an inspection frequency necessary for each of the zones at risk for the depth of corrosion to reach the predetermined limit depth;
a determining subunit for determining a proposed inspection frequency, the proposed inspection frequency being strictly less than the inspection frequency necessary for each of the zones at risk for the depth of corrosion to reach the predetermined limit depth.
